(19) United States
(12) Patent Application Publication
(10) Pub. No.: US 2013/0272679 A1
(43) Pub. Date: Oct. 17, 2013

(54) Video Generator System

(71) Applicant: Mario Luis Gomes Cavalcanti, Copenhagen (DK)

(72) Inventor: Mario Luis Gomes Cavalcanti, Copenhagen (DK)

(21) Appl. No.: 13/860,518

(22) Filed: Apr. 10, 2013

Related U.S. Application Data
(60) Provisional application No. 61/623,190, filed on Apr. 12, 2012.

(51) Int. Cl. H04N 9/87

(52) U.S. Cl. CPC H04N 9/87
USPC 386/282

(57) ABSTRACT

A computer implemented method and a video generator system (VGS) for generating a video are provided. The VGS acquires video templates from one or more sources and identifies one or more customizable elements in each video template. The VGS presents the video templates to a user device via an interactive interface for enabling selection and individual customization of each video template. The VGS acquires a selection of one or more video templates from the user device and renders the identified customizable elements of the selected video templates to the user device via the interactive interface. The VGS acquires media content for each rendered customizable element of the selected video templates from the user device via the interactive interface. The VGS generates the video by modifying each rendered customizable element of the selected video template using the acquired media content and collating the modified customizable elements of the selected video template.

### CROSS REFERENCE TO RELATED APPLICATIONS

This application claims the benefit of provisional patent application No. 61/623,190 titled “Movie Creation And Production System”, filed in the United States Patent and Trademark Office on Apr. 12, 2012.

The specification of the above referenced patent application is incorporated herein by reference in its entirety.

### BACKGROUND

Conventional methods for generating a video from a standard video template include inserting a customer's content, for example, footage, photographs, etc., manually into the standard video template for rendering a final video. This process of generating the video is typically performed by a video firm. The customer can then buy the final video from the video firm. However, manual insertion of the customer's content into the standard video template is time intensive and requires knowledge and expertise in handling software used for generating a video from the standard video template. Moreover, the customer cannot directly customize the standard video template and has minimal or no access to any preview of the video generated by the video firm. The customer has to buy the software used by video editing firms in order to view the preview and generate the video himself/herself.

Hence, there is a long felt but unresolved need for a computer implemented method and system that generates a video without requiring manual insertion of content and that reduces the time required and the monetary costs associated with generating the video. Furthermore, there is a need for allowing a user to directly generate the video from one or more video templates that are divided into multiple parts or customizable elements by selection, arrangement, and individual customization of each of the parts or the customizable elements of the video templates.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and the video generator system disclosed herein address the above stated needs for generating a video without requiring manual insertion of content. The computer implemented method and the video generator system disclosed herein allow a user to directly generate the video from one or more video templates that are divided into multiple parts or customizable elements, by selection, arrangement, and individual customization of each of the parts or the customizable elements of the video templates, and reduce the time required and the monetary costs associated with generating the video.

The computer implemented method disclosed herein provides a video generator system comprising at least one processor configured to generate the video. In an embodiment, the video generator system is downloadable, for example, as a software application on a user device. In another embodiment, the video generator system is accessible by the user device via a network, for example, the internet. The video generator system acquires multiple video templates from one or more of multiple sources, for example, from one or more third party video template vendors. As used herein, the term “video templates” refers to pre-developed video projects that can be configured to create customized videos with a predefined design and style.

The video generator system identifies one or more customizable elements in each of the video templates. As used herein, the term “customizable elements” refers to elements from the video templates that can be modified or replaced by the video generator system. The customizable elements comprise, for example, scenes, music, special effects, sound tracks, graphics, text, compositions, layer elements, etc. The video generator system identifies and modifies one or more properties of each of the identified customizable elements in each of the video templates. As used herein, the term “properties” refer to attributes of the customizable elements that control appearance of each of the customizable elements in the video generated by the video generator system. The properties are, for example, font, type, size, etc. In an embodiment, the video generator system tags each of the identified customizable elements in each of the video templates on acquisition of the video templates from the sources. The video generator system presents each of the identified customizable elements or parts to a user device via an interactive interface provided by the video generator system and allows each of the identified customizable elements or parts to be customized and previewed by the user via the interactive interface, prior to generating a preview video and a final video. The video generator system presents the sourced video templates comprising the identified customizable elements to a user device via the interactive interface for enabling selection, arrangement, and individual customization of each of the identified customizable elements of each of one or more of the presented video templates. The user can individually select and customize each presented video template.

The video generator system acquires a selection of one or more of the presented video templates from the user device via the interactive interface. The video generator system renders the identified customizable elements of the presented video templates to the user device via the interactive interface base on the acquired selection. The video generator system displays the identified customizable elements in each of the sourced video templates on the user device via the interactive interface. In an embodiment, the video generator system acquires an arrangement position for each of the rendered customizable elements of each of the selected video templates from the user device via the interactive interface. The video generator system acquires media content for each of the rendered customizable elements of a selected video template from the user via the interactive interface. The media content comprises, for example, one of video content, audio content, audiovisual content, image content, textual content, multimedia content, etc., or any combination thereof. The video generator system generates the video by modifying each of the rendered customizable elements of the selected video template using the acquired media content and collating them. In an embodiment, the video generator system collates the modified customizable elements of the selected video template using the acquired arrangement position of each of the rendered customizable elements. In an embodiment, the video generator system generates and presents a preview for each of the modified customizable elements of the selected video template on the user device via the interactive interface for acquiring approval of the modified customizable elements from the user device to proceed with the generation of the video.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 illustrates a computer implemented method for generating a video.

FIGS. 2A-2D exemplarily illustrate a flow diagram comprising front end processes and back end processes performed by a user and a video generator system respectively for generating a video.

FIGS. 3A-3B exemplarily illustrate a flow diagram showing creation, storage, and usage of files associated with generation of a video by the video generator system.

FIGS. 4A-4B exemplarily illustrate a table comprising template data associated with a template model file stored in a database.

FIGS. 5A-5C exemplarily illustrate content of a template model file of a video template comprising customizable elements identified by the video generator system for enabling selection and individual customization of the video template.

FIG. 6 illustrates a computer implemented system for generating a video.

FIG. 7 exemplarily illustrates the architecture of a computer system employed by the video generator system for generating a video.

FIG. 8A exemplarily illustrates a screenshot of an interactive interface provided by the video generator system, showing multiple video templates presented to a user.

FIGS. 8B-8C exemplarily illustrate screenshots of the interactive interface provided by the video generator system for acquiring media content for the identified customizable elements of a video template selected by a user.

FIG. 8D exemplarily illustrates a screenshot of the interactive interface of the video generator system for generating the video.

### DETAILED DESCRIPTION OF THE INVENTION

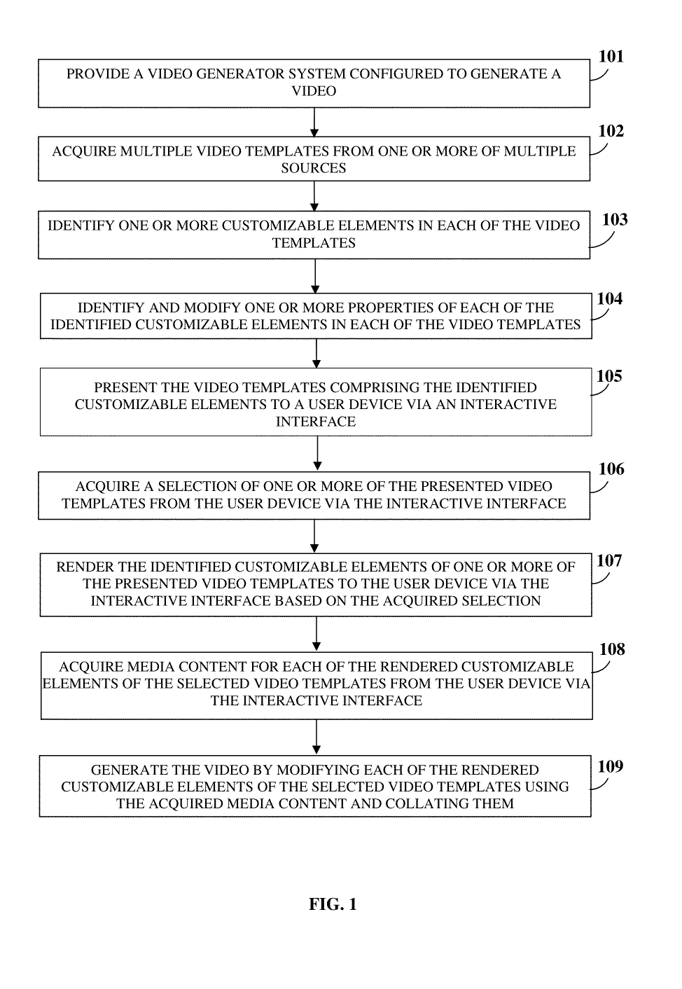

FIG. 1 illustrates a computer implemented method for generating a video. As used herein, the term “video” refers to a representation, for example, of a story, an event, a factual record, etc., in the form of a set of moving images. The video is, for example, a promotional video, a presentational video, a movie, etc. The computer implemented method disclosed herein provides 101a video generator system comprising at least one processor configured to generate the video. In an embodiment, the video generator system is implemented as a website or a web based platform hosted on a server or a network of servers. The video generator system is accessible by a user device via a network. The user device is an electronic device, for example, a personal computer, a tablet computing device, a mobile computer, a mobile phone, a smart phone, a portable computing device, a laptop, a personal digital assistant, a touch centric device, a workstation, a client device, a portable electronic device, a network enabled computing device, an interactive network enabled communication device, a gaming device, a television, an image capture device, a web browser, a portable media player, a theater system, any entertainment system, any other suitable computing equipment and combinations of multiple pieces of computing equipment, etc. The user device may also be a hybrid device that combines the functionality of multiple devices. Examples of a hybrid device comprise a cellular phone that includes media player functionality, a gaming device that includes a wireless communications capability, a cellular phone that includes game and electronic mail (email) functions, and a portable device that receives email, supports mobile telephone calls, has music player functionality, and supports web browsing. The network is, for example, the internet, an intranet, a wired network, a wireless network, a communication network that implements Bluetooth® of Bluetooth Sig, Inc., a network that implements Wi-Fi® of the Wireless Ethernet Compatibility Alliance, Inc., an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a long-term evolution (LTE) mobile communication network, a public telephone network, etc., a local area network, a wide area network, an internet connection network, an infrared communication network, etc., or a network formed from a combination of these networks. In another embodiment, the video generator system is downloadable, for example, as a software application on the user device.

The video generator system acquires 102 multiple video templates from one or more of multiple sources, for example, from one or more third party video template vendors. As used herein, the term “video templates” refers to pre-developed video projects that can be configured to create customized videos with a predefined design and style. The video templates are also referred to as “default templates” or “standard templates”. The video templates comprise, for example, one or more video files, raster based image files or vector based image files, sound files, drawings, and other graphical elements created using third party software applications. Also, as used herein, the term “third party video template vendors” refers to vendors of video templates comprising, for example, footage, website templates, motion graphics, Adobe® After Effects® project files of Adobe Systems Incorporated, other digital products, etc., generated using a software application or a software program, for example, a digital motion graphics software, a composition software, etc. An example of a third party video template vendor is Videohive.net of the Envato® marketplace of Envato Pty Limited. The video templates are, for example, project files generated using the Adobe® After Effects® software. The video generator system sources the video templates from the third party video template vendors.

The video generator system divides the video templates in various customizable elements or parts that can be presented to the user and can be customized, arranged, and previewed by the user via an interactive interface provided by the video generator system, before being collated to generate a custom video. The video generator system identifies 103 one or more customizable elements in each of the video templates. As used herein, the term “customizable elements” refers to elements from the video templates that can be modified or replaced by the video generator system. The customizable elements comprise, for example, scenes, music, special effects, sound tracks, graphics, text, compositions, layer elements, etc. The video templates that are sourced from the third party video template vendors need to be prepared prior to customization of the video templates. In an example, the video generator system opens a project file of a video template in a third party software application, for example, Adobe® After Effects® and tags the different elements that should be modified by the user. In an embodiment, the video generator system performs the tagging when the video templates are acquired from the sources. That is, the video generator system appends a specific name or a tag to each of the elements that should be modified by the user. The tagged elements are called the customizable elements. The customizable elements are defined in the third party software applications, for example, in the Adobe® After Effects® software as text, compositions, layer elements, etc. The video generator system identifies and modifies 104 one or more properties of each of the identified customizable elements in each of the video templates. As used herein, the term “properties” refer to attributes of the customizable elements that control appearance of each of the customizable elements in the video generated by the video generator system. The properties are, for example, font, type, size, etc. During the process of identifying the customizable elements in each of the video templates, the video generator system also identifies and adjusts the properties of the identified customizable elements.

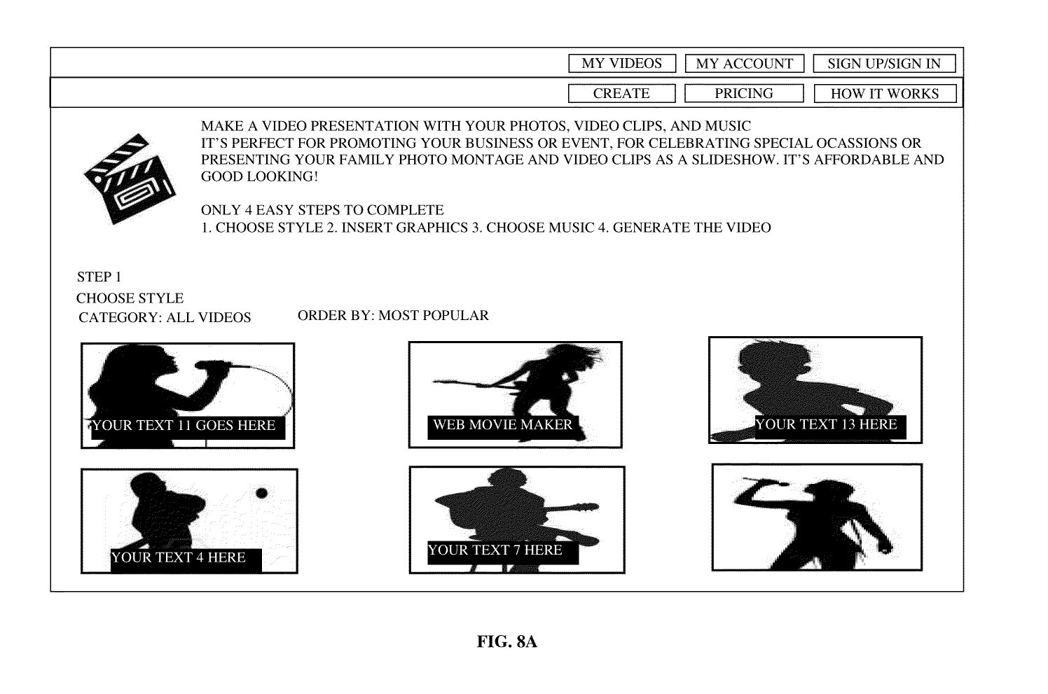

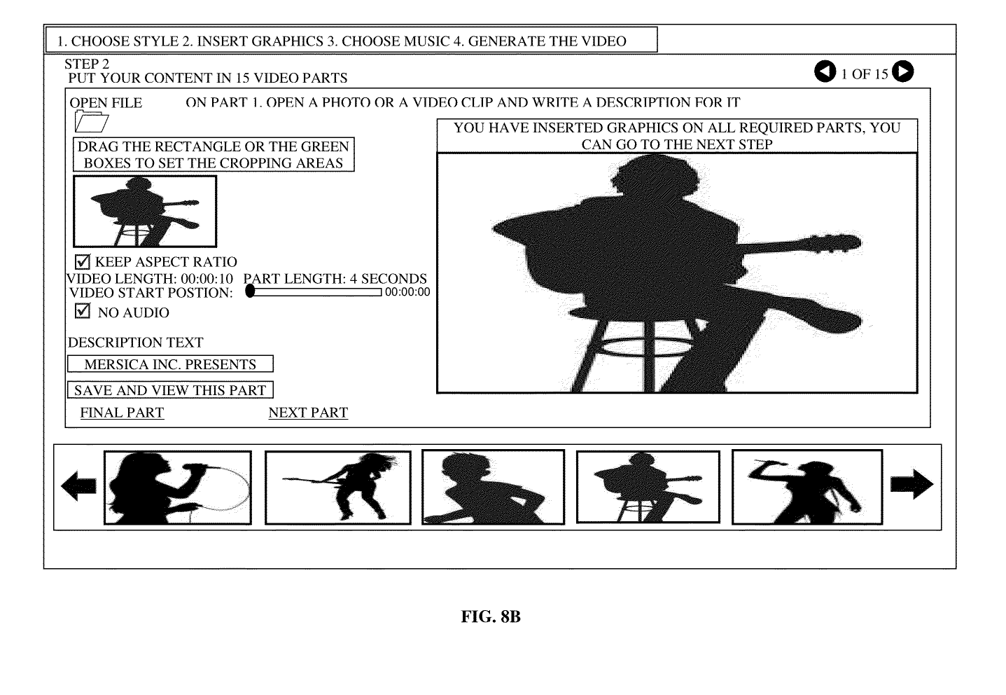

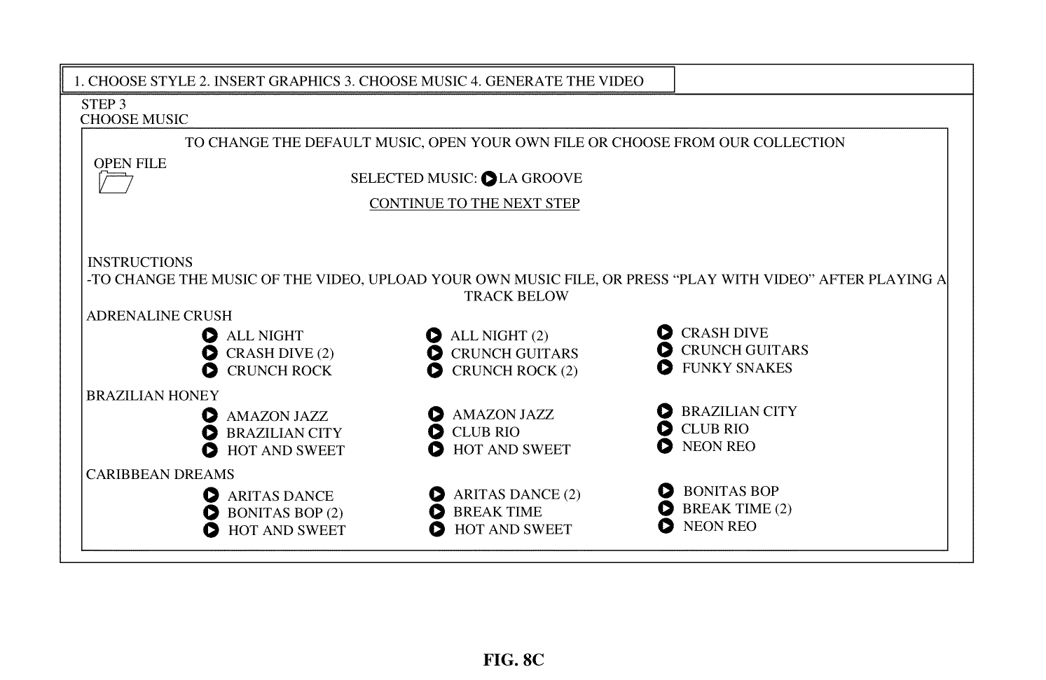

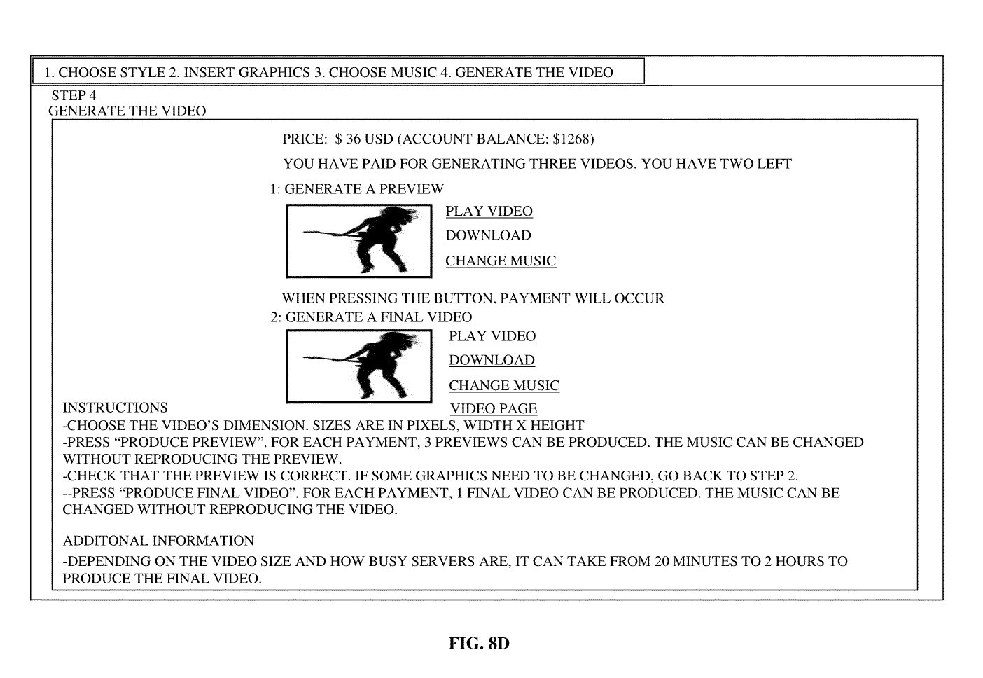

The video generator system presents 105 the sourced video templates comprising the identified customizable elements to the user device via the interactive interface provided by the video generator system, as exemplarily illustrated in FIG. 8A, for enabling selection, arrangement, and individual customization of each of the identified customizable elements of each of the presented video templates. The interactive interface is, for example, a webpage of a website hosted by the video generator system, an online web interface, a web based downloadable application interface, a mobile based downloadable application interface, etc. The user can select one or more of the presented video templates via the interactive interface.

The video generator system acquires 106 a selection of one or more of the presented video templates from the user device via the interactive interface. In an example, the user can select a video template from a list of video templates presented to the user. After selecting a video template to be used as the basis for the video, the video generator system presents the user with an interface for customizing or editing the video. This interface shows the video as being composed of multiple parts or customizable elements. The video generator system renders 107 the identified customizable elements of each of the selected video templates to the user device via the interactive interface as exemplarily illustrated in FIGS. 8B-8C. The video generator system highlights the identified customizable elements for easy recognition by the user. The video generator system presents each of the identified customizable elements to the user and allows each of the identified customizable elements to be customized and previewed by the user before the video is generated. The video generator system displays the identified customizable elements in each of the video templates on the user device via the interactive interface. The user can individually customize each of the rendered customizable elements of each of the selected video templates with the user's own media content. For example, the user can modify a particular customizable element by replacing and/or inserting, for example, text, images, video, audio, etc., and by changing various properties of the customizable element.

The video generator system acquires 108 media content for each of the rendered customizable elements of each of the selected video templates from the user device via the interactive interface. As used herein, the term “media content” refers to content in different combined and individual formats. The media content comprises, for example, one of video content, audio content, audiovisual content, image content, textual content, footage, graphics, still images, animations, rich content formats, multimedia content, etc., or any combination thereof. The media content is, for example, a photo clip, a video clip, a music track, a multimedia file, etc. In an example, the user uploads photographs and footage files to the video generator system via the interactive interface and writes text into fields representing the identified customizable elements, for example, video parts, scenes, etc., on the interactive interface.

In an embodiment, the video generator system acquires an arrangement position for each of the rendered customizable elements of each of the selected video templates from the user device via the interactive interface. The arrangement position determines the position of the customizable elements in the generated video. The video generator system presents each of the identified customizable elements to the user and allows each of identified customizable elements to be individually customized and previewed by the user before a final video is generated. In an example, the user can decide the starting position of each of the identified customizable elements in the generated video and enter the arrangement positions of each of the identified customizable elements via the interactive interface. Therefore, if the user wants a specific identified customizable element to be rendered in the beginning of the video, the user may arrange that identified customizable element by positioning that identified customizable element in front of the other identified customizable elements via the interactive interface.

The video generator system generates 109 the video by modifying each of the rendered customizable elements of the selected video template using the acquired media content and collating each of the modified customizable elements of the selected video template. The identified customizable elements of the selected video template are modified using the video generator system as well as third party software applications, for example, Adobe® After Effects® software, FFmpeg, sound eXchange (SoX) digital audio editor, MEncoder, MP4Box, etc., for performing various video processing and audio processing. Consider an example where the video generator system identifies 10 scenes and a music track of the selected video template as the customizable elements. The video generator system then modifies or replaces the existing scenes and the default music track on the selected video template with the media content acquired from the user as disclosed in the detailed description of FIGS. 8B-8C. In an example, the video generator system provides a “Generate the Video” interface element such as an icon or a button on the interactive interface for initiating generation of the video. In an embodiment, the video generator system collates the modified customizable elements of the selected video template using the acquired arrangement position of each of the rendered customizable elements.

In an embodiment, the video generator system generates and presents a preview for each of the modified customizable elements in each of the selected video templates on the user device via the interactive interface for acquiring approval of each of the modified customizable elements from the user device to proceed with the generation of the video on receipt of the user's approval. As used herein, the term “preview” refers to a presentation of a sample clip of a modified customizable element. For allowing a user to preview the video, the video generator system generates, for example, a preview image or a preview video for a particular customizable element. The video generator system generates the preview for each of the video templates based on the media content acquired for the respective video templates. The computer implemented method and the video generator system disclosed herein thereby fully automate the process of customizing a video template by identifying the different customizable elements in the video template and presenting the identified customizable elements to the user as different parts or elements that the user can modify via the interactive interface, for example, through an online web service. The computer implemented method and the video generator system disclosed herein allow a user to post media content, for example, graphics, text, footage, music, etc., that the user wants in the video via the interactive interface and the video generator system generates the video with the user's media content incorporated in the video. The video generator system thereby renders the video ready for download within a short duration, for example, in about a few minutes.

The video generator system enables the user to generate the video based on a video template made using a third party software application, for example, Adobe® After Effects®. That is, the video generator system can open and customize project files generated using the Adobe® After Effects® software and provide a fully automated solution for generating the video. In an embodiment, the video generator system acquires payment from the user prior to generation of the preview video for generation of the video as disclosed in the detailed description of FIG. 8D. In another embodiment, the video generator system performs acquisition of payment after the preview video has been generated to allow the user to decide whether the final video is worth paying for. In another embodiment, the payment step is not performed to allow certain video templates to be used for generating videos free of charge.

In an embodiment, the video generator system generates a preview video for a selected video template prior to generation of a final video. As used herein, the term “preview video” refers to a video that is rendered by the video generator system for providing the user a fast preview of the modified customizable elements of the selected video template that are collated. In an example, the payment acquired from the user includes the generation of at least 1 preview video for each selected video template and 1 final video. Moreover, the payment from the user includes an unlimited number of replacements of the music track of the video, thereby allowing the user to change the music track at any time after the video has been generated. The generation of preview videos speeds up the process of generation of the final video and provides the user with a fast preview of the collated customizable elements, thereby allowing the user to return to previous steps and make additional modifications to the customizable elements. The video generator system renders the final video in high quality as disclosed in the detailed description of FIG. 8D, which slows the rendering of the final video. The video generator system allows the user to have at least 1 preview video generated before the final video is generated. This is to allow the user to find and correct mistakes prior to initiating the much more resource intensive in terms of, for example, a central processing unit (CPU), a random access memory (RAM), bandwidth, etc., final video generation.

The computer implemented method and the video generator system disclosed herein therefore automate the process of customizing standard or default video templates such that the user's media content, for example, footages, images, text, music files, etc., is automatically inserted into the selected video template. Once the user submits the media content, manual labor is no longer required in order to customize and render videos based on the selected video template. This makes it possible for users that do not have the expertise or do not own any digital motion graphics and composition software, for example, Adobe® After Effects®, to generate videos based on the video templates provided by the third party video template vendors. The videos are based on video templates that are divided into various parts or customizable elements, where each part or customizable element is presented to the user for customization, editing, and preview. The users can generate the video directly through the interactive interface provided by the video generator system. The computer implemented method and the video generator system disclosed herein thereby remove the need for manual labor in generating the video based on the selected video template and considerably reduces the time required and the monetary costs associated with generating the video.

Consider an example where a user wishes to generate a video for creating and producing a movie. The user accesses the video generator system on a user device, for example, a tablet computing device, a smart phone, an internet protocol enabled device on an internet connection, an internet enabled mobile device, a computer with a web browser, etc., via the interactive interface. The video generator system presents multiple video templates to the user via the interactive interface of the video generator system. The user selects one of the video templates from the presented video templates, for example, by clicking on one of the presented video templates. The video generator system acquires the selection of the video template and renders the identified customizable elements of the selected video template to the user via the interactive interface. In this example, the video generator system identifies 5 scenes of the selected video template as the customizable elements and allows the user to arrange the scenes for rendering the scenes in a specific order determined by the user. The video generator system renders each of the 5 scenes of the selected video template to the user and prompts the user to upload media content for each of the 5 scenes of the selected video template via the interactive interface. The video generator system modifies the 5 scenes with the acquired media content and presents a preview of each of the 5 scenes to the user for approval via the interactive interface. On receiving approval for the 5 scenes of the selected video template, the video generator system provides an option of choosing a music track from a list of music tracks to the user. The video generator system also allows the user to upload a music track of the user's choice. If the user wishes to modify the music track of the selected video template, the video generator system acquires the music track from the user device via the interactive interface. The video generator system acquires payment from the user for generating, for example, 1 preview video of the selected video template and the final video. The video generator system generates the preview videos when requested by the user and displays the preview videos on the interactive interface for selection by the user. The video generator system renders the final video separately. The user can download the final video to the user device or stream the final video for viewing on the user device.

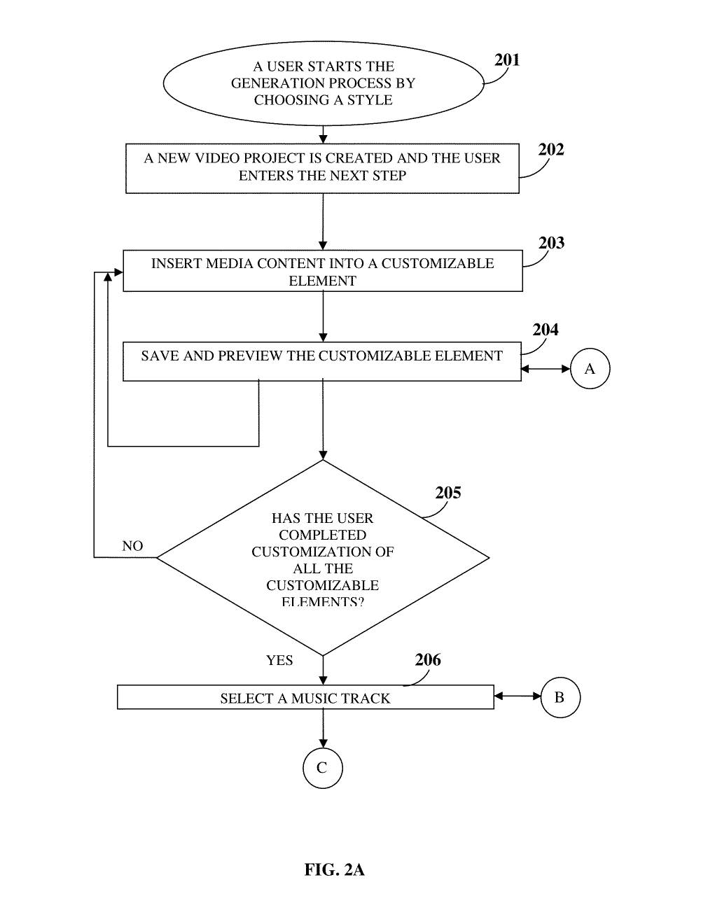

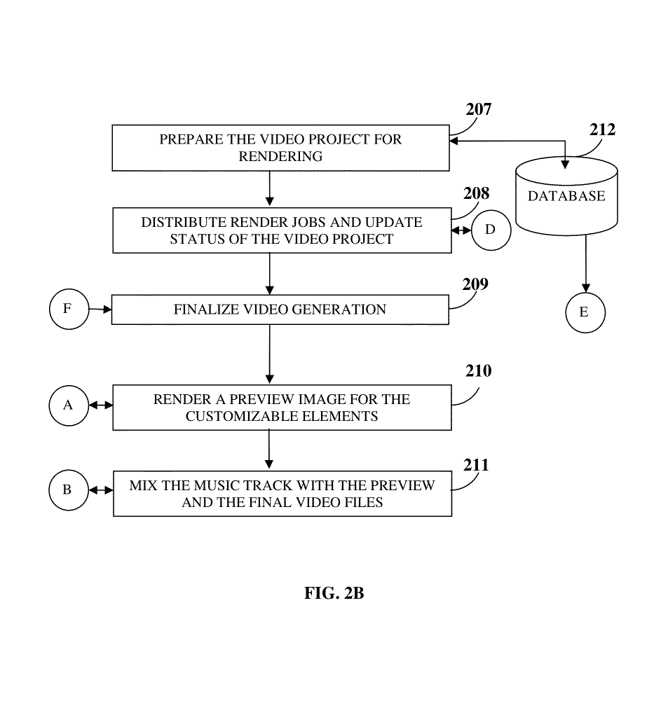

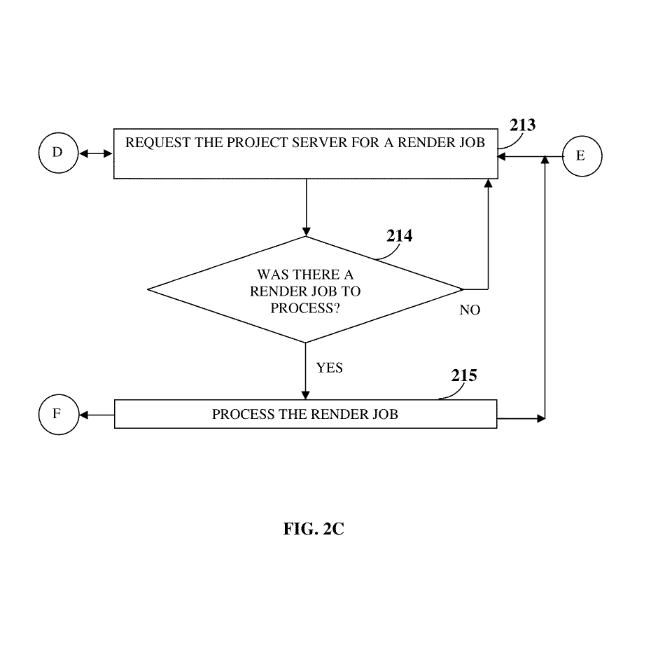

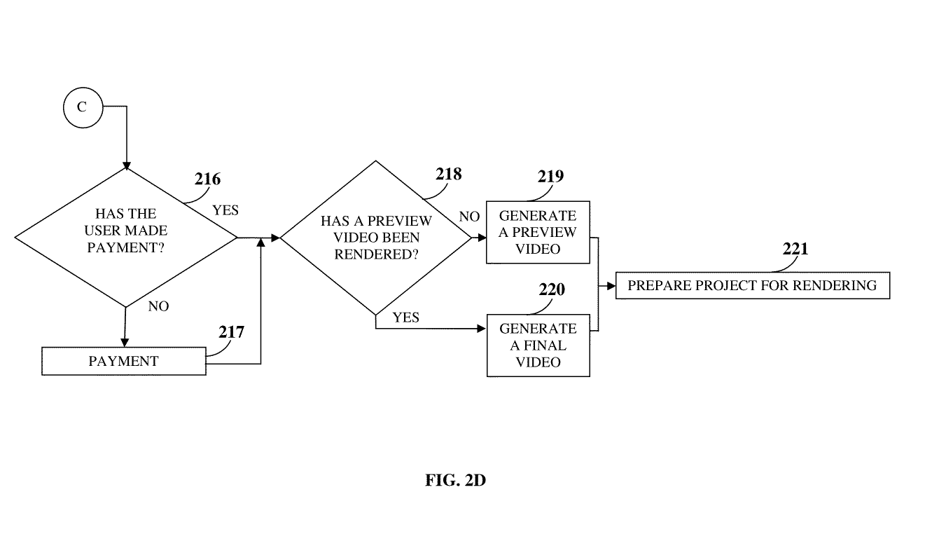

FIGS. 2A-2D exemplarily illustrate a flow diagram comprising front end processes and back end processes performed by a user and the video generator system respectively for generating a video. Consider an example where a user wishes to generate a video. The user starts 201 the video generation process by choosing a style, that is, by selecting a video template from the video templates presented on the interactive interface provided by the video generator system. The video generator system creates 202 a new video project containing a template model file for the selected video template and allows the user to enter the next step. As used herein, the term “template model file” refers to a file created for each video template and incorporated manually in the video generator system prior to making the video template available to the users. The template model file contains multiple different properties that are used by the video generator system, for example, properties related to the tags used to identify the customizable elements of the video template. The video generator system uses the information stored in the template model file to process the video template in order to generate preview images, a preview video, and a final video. When a new video project is created, the video generator system stores a copy of the template model file inside a project folder. The video generator system modifies the copy of the template model file by replacing some of the property values with values gathered via the interactive interface presented to the user, thereby allowing generation of a customized video based on the given video template. Also, as used herein, the term “video project” also referred to as a “template project file” refers to a collection of files needed to render a customized video based on a video template. The video project or the template project file contains the template model file among other files. The video project comprises folders and files in a proprietary format specified by the video generator system, as well as files in formats specified by a third party video software application used to render the video.

The video generator system renders the identified customizable elements of the selected video template to the user via the interactive interface for insertion 203 of media content, for example, graphics into each identified customizable element. For a given customizable element, the user uploads the media content, for example, an image file, a video file, assets, written text lines, etc., to the video generator system via the interactive interface. The video generator system updates the template model file in the video project using the uploaded media content and prepares the media content files also referred to as asset files, for example, by scaling, cropping, etc. The video generator system allows the user to save and preview 204 each customizable element. The video generator system modifies the template model file with the acquired media content for each customizable element in the project folder and initiates generation and rendering of the preview for each customizable element. The video generator system renders a preview image for each customizable element. The video generator system comprises one or more project servers and one or more render servers. The project server of the video generator system generates and renders 210 a preview or a preview image for each of the modified customizable elements to the user via the interactive interface. After the user uploads the media content, for example, an asset, written text, etc., for a given customizable element, the project server generates the preview, for example, in the form of a preview image. The video generator system checks 205 whether the user has completed customization of all the identified customizable elements and repeats steps 203 and 204 until the user has completed customization of all the identified customizable elements. The video generator system repeats steps 203 and 204 until the video generator system acquires the media content for all the identified customizable parts or customizable elements, modifies the identified customizable elements, and generates the preview for each of the modified customizable elements.

FIG. 2B exemplarily illustrates the steps performed by the project server of the video generator system. As exemplarily illustrated in FIG. 2B, on acquiring the media content from the user, the project server of the video generator system prepares 207 the video project for generation and rendering in the back end. That is, the project server executes customization scripts, for example, Adobe® After Effects® scripts to create a custom project file, for example, a custom Adobe® After Effects® project file by reading the template model file and inserting the acquired media content, for example, user assets, text, etc., into the template model file. The customization script refers to a software program written for a command interpreter or for a scripting language to enable modification of the identified customizable elements of the selected video template. As used herein, the term “custom project file” also referred to as a “custom template project” refers to a new project file generated in a format specified by the third party video software application used to render the video, after the video generator system processes the template model file. In order to generate the preview images, the preview video, and the final video, the video generator system using a third party video software application opens the custom project file and starts the rendering process. The project server stores the created custom project file in a database 212 of the video generator system. The project server creates multiple render jobs and places the render jobs in a job queue to split the video generation process among various render servers of the video generator system. When a render server has available processing capability, the render server requests 213 the project server for a render job as exemplarily illustrated in FIG. 2C. The project server distributes 208 the render jobs to the render servers and updates the status of the video project based on the results of the distribution of the render jobs and the renderings.

FIG. 2C exemplarily illustrates the steps performed by the render server of the video generator system. As exemplarily illustrated in FIG. 2C, the render server checks 214 whether there is a render job to process. If there is no render job to process, the render server requests 213 the project server for a render job. If there is a render job to process, the render server processes 215 the render job. To process the render job, the render server downloads the video projects, the associated template model files, and the acquired media content and assets from the project server. The render server then initiates a rendering tool, for example, Adobe® aerender tool for rendering the video project at a frame range defined for the render job. The render server generates a video file on completion of processing of the render job. The render server transmits the video file to the project server. The render server then requests 213 for another render job.

As exemplarily illustrated in FIG. 2A, the video generator system checks 205 whether the media content has been acquired from the user for all the identified customizable elements. If the media content has not been acquired from the user for all the identified customizable elements via the interactive interface, the video generator system repeats steps 203 to 205. If the media content has been acquired from the user for all the identified customizable elements via the interactive interface, the video generator system enables the user to select 206 a music track for the video. If a preview video or a final video has already been generated, the video generator system enables the user to preview the selected music track with the video rendered. The user can select the music track from a list or a collection of music tracks provided by the video generator system or the user can upload a music file containing the music track from the user device. If the user has already generated a video, the user can preview the selected music with the video rendered by the video generator system.

When all the render jobs are processed by the render servers, the project server finalizes 209 generation of the video. The project server stores a separate video file from each of the render servers as a result of processing each of the render jobs. The project server merges the video files into a single video file, mixes the music, and notifies the user that the video has been generated and is ready for download. When the music track has been selected by the user, the project server mixes 211 the music track with the generated video, that is, the preview video or the final video. The video generator system enables the user to change the music file for all the generated videos, that is, the preview videos and the final video.

As exemplarily illustrated in FIG. 2D, the video generator system checks 216 whether the user has made the payment for generating the video. If the user has not made the payment, the video generator system acquires 217 the payment from the user's account maintained or accessible by the video generator system if there are enough funds in the user's account, or prompts the user to deposit the payment, for example, via an electronic commerce platform such as PayPal® of PayPal Inc. If the user has made the payment, the video generator system checks 218 whether the preview video has been rendered. If the preview video has not been rendered, the video generator system generates 219 the preview video. If the preview video has been rendered, the video generator system generates 220 the final video. The video generator system prepares 221 the video project for generating and rendering the video. The video generator system creates various rendering jobs to split the video rendering process among multiple servers. The user can wait until all the render jobs distributed to the render servers have been processed. The user can follow the video generation process by visiting or staying on a webpage of the interactive interface provided by the video generator system. In an embodiment, the video generator system transmits a notification to the user device, for example, via electronic mail (email), a short message service (SMS) message, etc., on completion of generation of the video and the video rendering process.

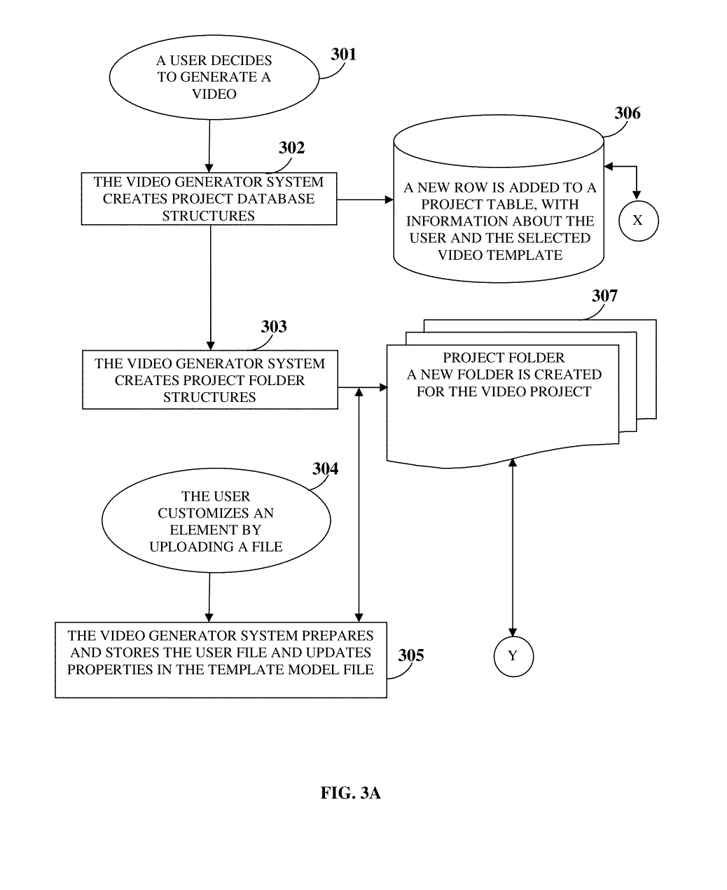

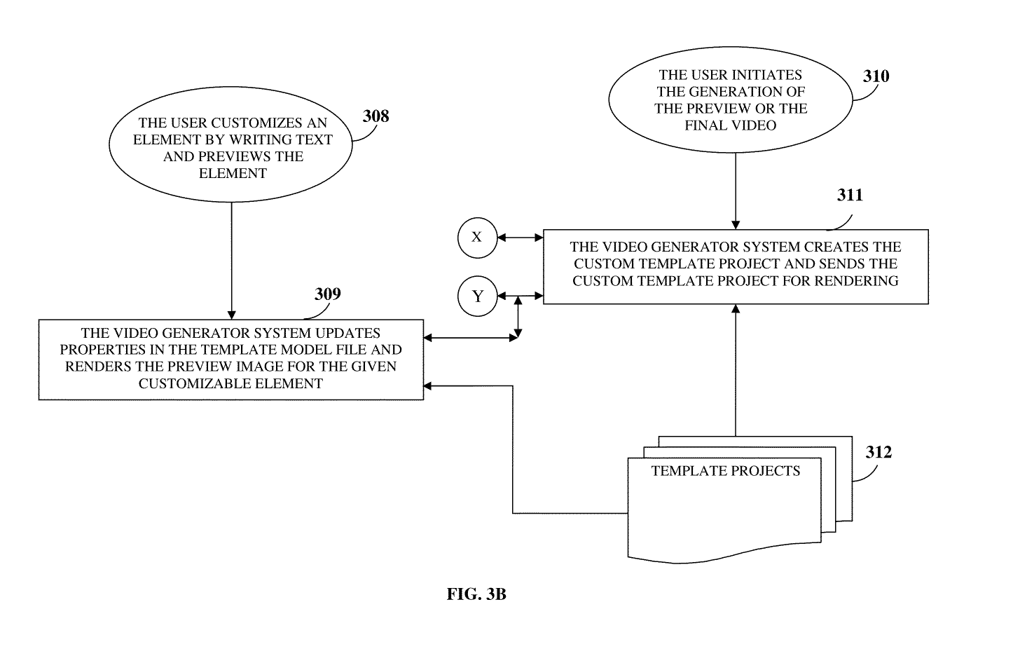

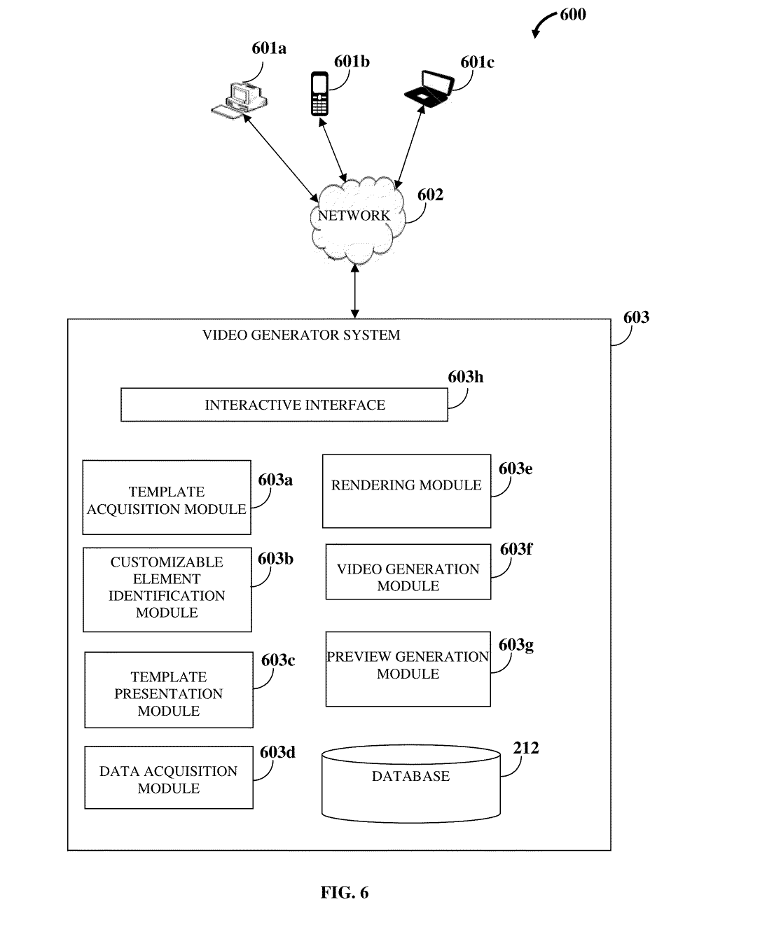

FIGS. 3A-3B exemplarily illustrate a flow diagram showing creation, storage, and usage of files associated with generation of a video by the video generator system. FIGS. 3A-3B also illustrate dependencies between the various files created during the process of generating the video. Other structures, for example, file based structures and database based structures may also be used during generation of the video. Consider an example where a user decides to generate 301 a video, for example, a movie. The video generator system creates 302 project database structures in the database 212 exemplarily illustrated in FIG. 2B and FIG. 6. The video generator system stores project data in the database 212 with information about the video template selected by the user and other relevant information. A new row is added 306 to a project table in the database 212 with information about the user and the selected video template.

Furthermore, the video generator system creates 303 project folder structures. That is, the video generator system creates 307 a project folder for a video project. The video generator system then copies the template model file of the selected video template into the project folder. The video generator system creates the project folder and copies the template model file into the project folder, for example, using a typical computer file system. The project folder initially only contains the copy of the template model file. During the process of generation of the video, the project folder also stores the media content acquired from the user, the previews, files of the generated video, etc. The user modifies or customizes 304 each of the customizable elements, for example, by uploading a file of media content for each of the customizable elements. The video generator system prepares and stores 305 the acquired media content, that is, the user files in the database 212 and updates the properties of the customizable elements in the template model file. For example, if the acquired media content is an image or a video file, the video generator system scales or crops the acquired media content. The video generator system then stores the updated template model file in the project folder and adds or updates the properties inside the template model file.

The video generator system enables the user to customize 308 a customizable element, for example, by writing text, and preview the modified customizable element using the preview generated by the video generator system. The video generator system updates 309 the properties of the customizable elements in the template model file and renders a preview image for the given customizable element. For example, the video generator system locates and modifies text element properties in the template model file. The video generator system initiates a third party software application such as the Adobe® After Effects® software and executes the customization script. The customization script reads the updated template model file and customizes the video template by inserting the uploaded media content, text, and other modifications into the template model file in the project folder. The video generator system renders a preview image at a video frame position of the given customizable element and, in an embodiment, discards the modified video project. The video generator system stores the preview image in the project folder and presents the preview image to the user via the interactive interface.

The user initiates 310 the generation of the preview video or the final video, for example, by clicking on the “Generate the Video” link as exemplarily illustrated in FIG. 8D. The project server of the video generator system creates 311 a custom template project and sends the custom template project for rendering. The project server executes the customization script by starting the Adobe® After Effects® software. The customization script reads the template model file and customizes the template model file by inserting the acquired media content, text, and other modifications into the template model file. The project server stores the modified template model file in the project folder as a new custom template project or a custom project file. The project server creates render jobs. Each render server downloads the custom project file and initiates rendering and generation of the video. The render server sends the video file generated during the rendering process to the project server. The project server stores the video file in the project folder. The video generator system stores 312 the template project files in a template projects folder or in the database 212.

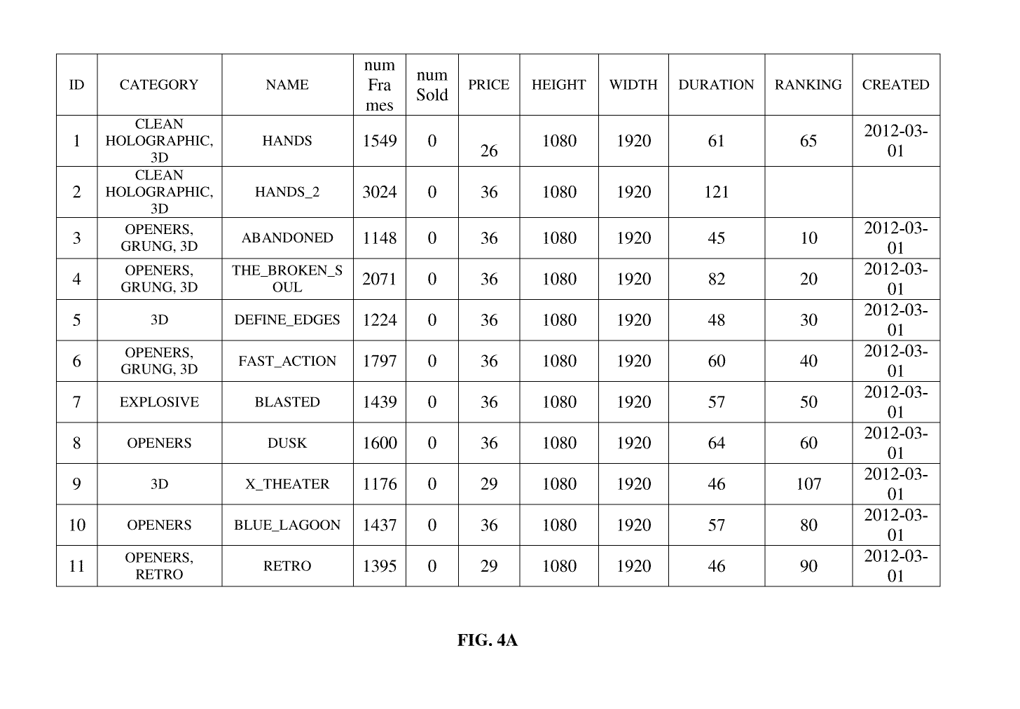

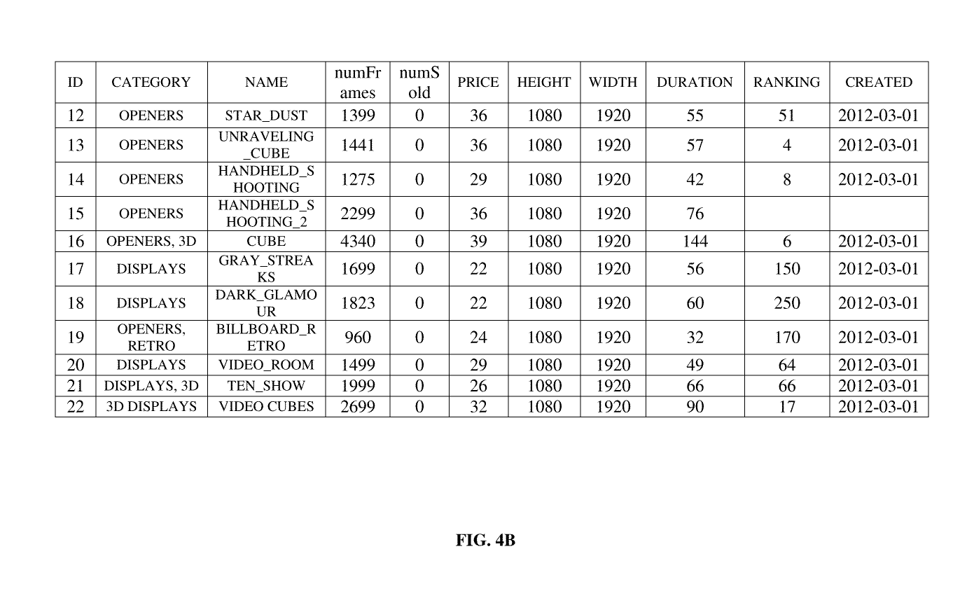

FIGS. 4A-4B exemplarily illustrate a table comprising template data associated with the template model file stored in the database 212 exemplarily illustrated in FIG. 2B and FIG. 6. Each row in the table comprises a record of template data of a video template. Each record of template data is identified by an identifier (ID). The video generator system stores, for example, the identifier (ID), a template category, a template name, number of frames in a video, price, height, width, duration of the video, ranking, date of creation, etc., for each record of template data in the table of the database 212.

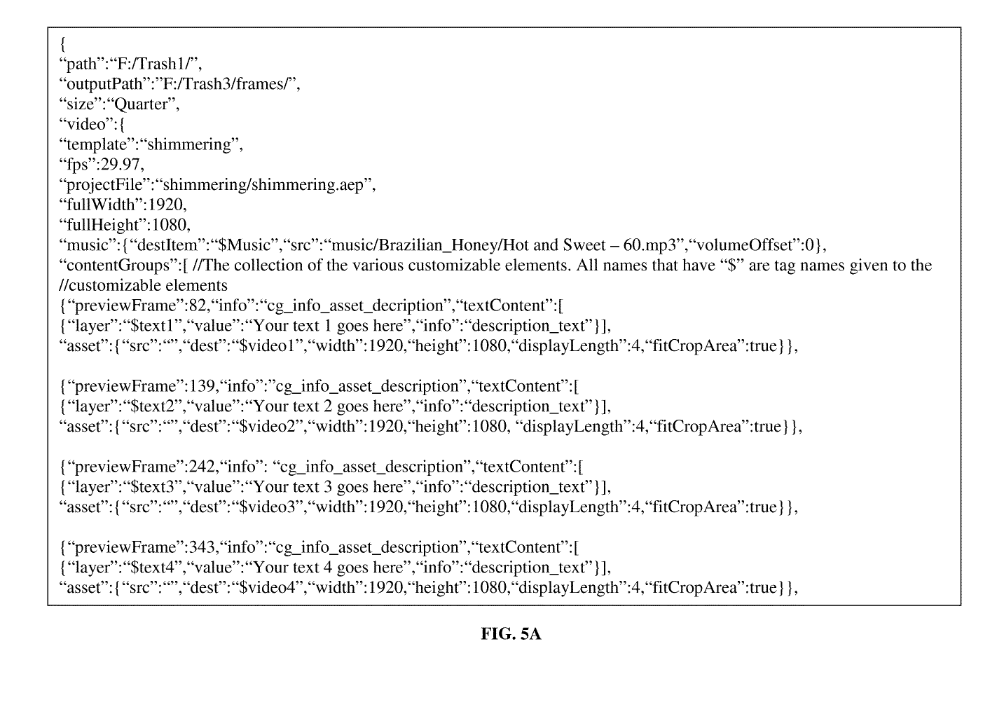

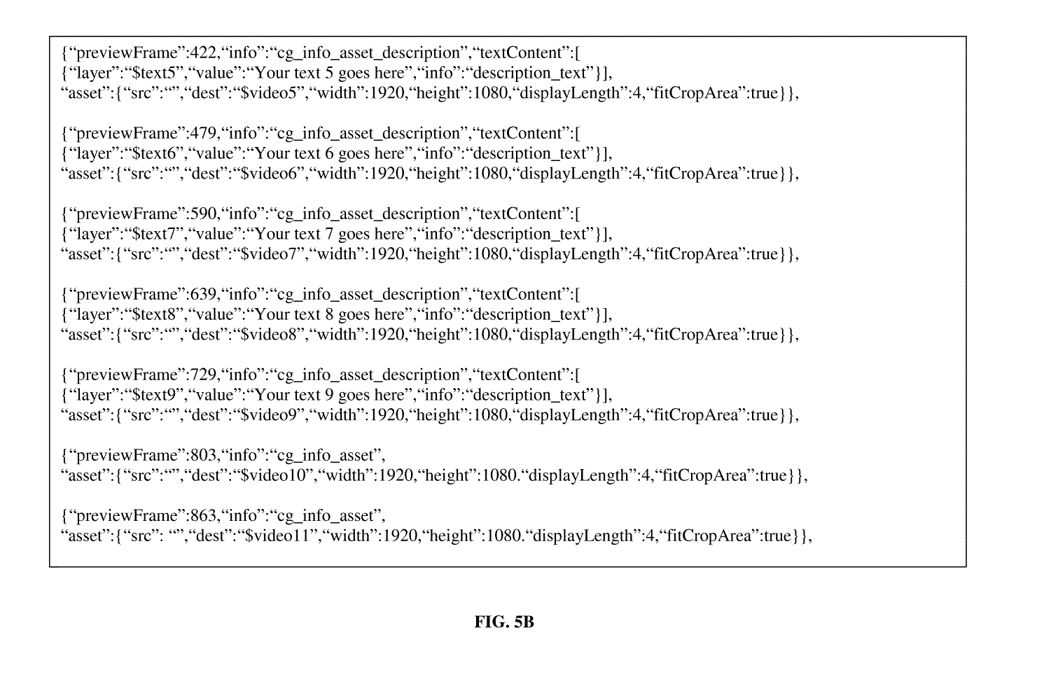

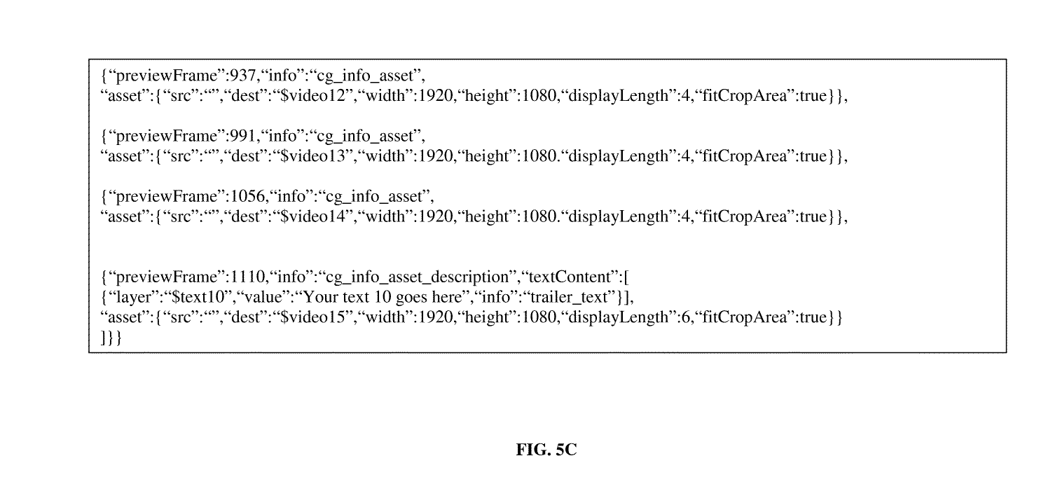

FIGS. 5A-5C exemplarily illustrate content of a template model file of a video template comprising customizable elements identified by the video generator system for enabling selection and individual customization of the video template. The template model file comprises, for example, the identified customizable elements, the modified properties, etc. The template model file of the video template further comprises software programming language codes used for acquiring media content for each of the rendered customizable elements from the user device, generating multiple preview frames, and presenting the preview frames on the user device. The template model file of the video template holds various properties and values used by the video generator system to produce a custom project file as disclosed in the detailed description of FIG. 2B. The software programming languages used for creating the template model file are, for example, Java, JavaScript®, a hypertext preprocessor (PHP) scripting language, C++, or any programming language that generates text based template model files. In an example, the video generator system uses the JavaScript® object notation (JSON) format, which is a text based format for generating the template model file. The video generator system may also generate the template model file using an extensible markup language (XML), binary formats, etc. In an embodiment, the video generator system expresses the template model file, for example, as tables, rows, and columns in the database 212 exemplarily illustrated in FIG. 2B and FIG. 6. Therefore, the template model file can be structured and persisted in many different formats, for example, in a text based format, a binary based format, a file persistent format, a database persistent format, etc.

In an embodiment, the video generator system identifies multiple customizable parts in the video templates, with each customizable part having different properties. As used herein, the term “customizable part” refers to a collection of one or more customizable elements. That is, each customizable part comprises one or more customizable elements. In an example, the template model file of the video template comprises customizable parts defined inside a “content group” JSON array. The term “content group” refers to an array comprising various JSON objects, each being a customizable part comprising various layer and asset definitions which are the customizable elements. The video generator system can therefore determine at which point in time the generation of the preview for a modified customizable element should be initiated. Each of the customizable parts comprises, for example, a photograph, an image, a video clip, several text lines, etc. The video generator system structures and stores the identified customizable elements, the customizable parts, the associated information, etc., in the template model file. The video generator system also stores template data, exemplarily illustrated in FIGS. 4A-4B, for example, in a table in the database 212. The video generator system uses the template model file to identify the different customizable elements in the video template and other information, for example, a name of a music track, a template name, a video dimension, and any other data required to complete the generation of the video using the selected video template.

The video generator system creates a video project configured as a template project file when the user decides to generate a new video from one of the presented video templates. Moreover, the video generator system creates a project folder for the video project. The project folder contains the template model file and all other files necessary to generate the video. Furthermore, the video generator system stores the media content acquired from the user along with the template model file in the project folder. In an embodiment, the template model file only holds the values of the properties of the customizable parts. Some of the properties of the customizable parts are modified by the user via the interactive interface and some the properties are modified by the video generator system. The video generator system stores the media content files uploaded by the user separately in the same project folder. The video generator system stores the project folder as a regular folder in a computer file system, or may also store the project folder entirely in the database 212. In an embodiment, the video generator system uses typical computer folders for file storage for convenient transfer of the folders between computing devices.

The database 212 of the video generator system stores user data, project data, and miscellaneous template data, that are not stored in the template model file, as well as other data necessary to run and control the generation of the video. The template model file is stored, for example, as a text file in the computer file system. The project folder which includes the template model file and the media content acquired from the user can be downloaded from the video generator system to the user device via the network for storage. The template model file in the user's project folder comprises the identified customizable elements, the modified properties, etc.

Initially, the project folder of the video project contains a copy of the template model file. The acquired file based media content, for example, the files uploaded by the user are also stored in the project folder. The video generator system performs the process of generating the previews for the identified customizable elements, the preview video, and the final video based on the information in the template model file and the files in the project folder. The video generator system stores text and properties of the customizable parts and/or the customizable elements of a video template in the template model file. The video generator system may store project data in the database 212, but may not utilize the project data for the generation of the video. The video generator system may therefore generate the video using the project folder and the files belonging to the selected video template.

The video generator system reads and parses the template model file using a customization script developed, for example, using the Adobe® After Effects® extendscript language, and modifies the video project, also referred to as the template project file, for a given video template. The video generator system performs the customization of the template project file using the developed customization script. When the video generator system completes the execution of the customization script, the result may be a preview for a modified customizable element, a video file, a new video template also referred to as a custom project file, which is required for rendering of a video into a video file. The custom project file is a fully customized version of the template project file that comprises the acquired media content, for example, different text, images, video files, etc., uploaded by the user. The video generator system only needs to provide the custom project file as an input to the video generation processes for generating the video.

In an embodiment, the video generator system comprises a single server for generating the video. In another embodiment, the video generator system comprises multiple servers, for example, render servers, project servers, etc., that collaborate for generating and rendering the video to the user. The custom project file is copied to each of the servers participating in the rendering process. In an embodiment, the video generator system divides the process of generating the video by splitting the process into multiple render jobs, such that each render server renders only certain frames of the video. The video generator system places the render jobs in a job queue. The render servers participating in the video generation process pick the render jobs from the job queue when processing capacity, for example, of a random access memory (RAM), a central processing unit (CPU), etc., is available to process the render jobs as disclosed in the detailed description of FIGS. 2A-2D. The render servers process the render jobs and output video files. The project server retrieves the video files from each of the render servers and collates the video files to generate the video. When a user initiates generation of the video, for example, by clicking on the “Generate the Video” button on the interactive interface exemplarily illustrated in FIG. 8D, the video generator system creates the custom project file and various render jobs. The video generator system picks up the render jobs from the job queue as soon as there is available processing capability and initiates customizing the template project file to create the custom project file. For each render job, the video generator system starts the third party software applications, for example, Adobe® After Effects® tools that are necessary to complete the rendering of a frame range associated with the render job. The video comprises multiple frames in sequence. The frames are still images which compose a complete moving picture. The term “frame range” refers to a range comprising a start frame from which the generation of the video initiates and an end frame at which the generation of the video terminates.

FIG. 6 illustrates a computer implemented system 600 for generating a video. The computer implemented system 600 disclosed herein comprises the video generator system 603 accessible by a user device, for example, a personal computer 601a, a mobile phone 601b, a laptop computer 601c, etc., via the network 602. The network 602 is, for example, the internet, an intranet, a local area network, a wide area network, a communication network implementing Wi-Fi® of the Wireless Ethernet Compatibility Alliance, Inc., a cellular network, a mobile communication network, etc. In an embodiment, the computer implemented method and system 600 disclosed herein provide a web browser based access to the video generator system 603. Web browsers used for accessing the video generator system 603 comprise, for example, Internet Explorer® (IE) of Microsoft Corporation, Mozilla® of Mozilla Foundation Corporation, Chrome of Google, Inc., Safari® of Apple, Inc., etc. In an embodiment, the video generator system 603 is implemented as a software application downloadable on a user device, for example, 601a, 601b, or 601c. The video generator system 603 comprises at least one processor configured to execute modules 603a, 603b, 603c, 603d, 603e, 603f, 603g, 603h, etc., of the video generator system 603. The video generator system 603 further comprises a non-transitory computer readable storage medium communicatively coupled to the processor. The non-transitory computer readable storage medium is configured to store the modules 603a, 603b, 603c, 603d, 603e, 603f, 603g, 603h, etc., of the video generator system 603.

The video generator system 603 comprises an interactive interface 603h, a template acquisition module 603a, a customizable element identification module 603b, a template presentation module 603c, a data acquisition module 603d, a rendering module 603e, a video generation module 603f, a preview generation module 603g, and a database 212. The template acquisition module 603a acquires multiple video templates from one or more sources, for example, from one or more third party video template vendors. The customizable element identification module 603b identifies one or more customizable elements in each of the video templates. The customizable element identification module 603b tags each of the identified customizable elements in each of the video templates on acquisition of the video templates from the sources. In an embodiment, the customizable element identification module 603b identifies and modifies one or more properties of each of the identified customizable elements in each of the video templates. The customizable element identification module 603b displays the identified customizable elements in each of the video templates on the user device, for example, 601a, 601b, or 601c via the interactive interface 603h. The template presentation module 603c presents the video templates comprising the identified customizable elements to a user device, for example, 601a, 601b, or 601c, via the interactive interface 603h for enabling selection, arrangement, and individual customization of each of the identified customizable elements of each of one or more of the presented video templates.

The data acquisition module 603d acquires a selection of one or more of the presented video templates from the user device, for example, 601a, 601b, or 601c, via the interactive interface 603h. The rendering module 603e renders the identified customizable elements of each of the selected video templates to the user device, for example, 601a, 601b, or 601c via the interactive interface 603h. In an embodiment, the data acquisition module 603d further acquires an arrangement position for each of the rendered customizable elements of the selected video templates from the user device, for example, 601a, 601b, or 601c via the interactive interface 603h. The data acquisition module 603d further acquires media content comprising, for example, video content, audio content, audiovisual content, image content, textual content, multimedia content, etc., and any combination thereof, for each of the rendered customizable elements of each of the selected video templates from the user device, for example, 601a, 601b, or 601c via the interactive interface 603h. The video generation module 603f generates the video by modifying each of the rendered customizable elements of a selected video template using the acquired media content and collating the modified customizable elements of the selected video template. In an embodiment, the video generation module 603f collates the modified customizable elements of the selected video template using the acquired arrangement position of each of the rendered customizable elements. The preview generation module 603g generates and presents a preview for each of the modified customizable elements of each of the selected video templates on the user device, for example, 601a, 601b, or 601c via the interactive interface 603h for acquiring approval of each of the modified customizable elements from the user device, for example, 601a, 601b, or 601c to proceed with the generation of the video. In an embodiment, the data acquisition module 603d, the rendering module 603e, the video generation module 603f, and the preview generation module 603g are implemented on the project server (not shown) disclosed in the detailed description of FIGS. 2A-2D. The project server creates multiple render jobs and places the render jobs in a job queue to split the video generation process among various render servers of the video generator system 603.

The interactive interface 603h displays the sourced video templates, the identified customizable elements of each of the video templates, the acquired media content from the user device, for example, 601a, 601b, or 601c, the previews, the final generated video, etc. The database 212 of the video generator system 603 stores user data, project data, and miscellaneous template data, that are not stored in a template model file generated from the project file or the template file of the video template, as well as other data necessary to run and control the generation of the video. The database 212 also stores template data associated with each of the video templates, information on the identified customizable elements of each of the video templates, information on the properties of each of the identified customizable elements in each of the video templates, information on the acquired selection of the presented video templates, the acquired media content, etc. The database 212 is, for example, a structured query language (SQL) data store or a not only SQL (NoSQL) data store such as the Microsoft® SQL Server®, the Oracle® servers, the MySQL® database of MySQL AB Company, the mongoDB® of 10gen, Inc., the Neo4j graph database, the Cassandra database of the Apache Software Foundation, the HBase™ database of the Apache Software Foundation, etc. In an embodiment, the database 212 can also be a location on a file system. The database 212 is any place that can be used for storing data and files. In another embodiment, the database 212 can be accessed remotely by the video generator system 603 via the network 602.

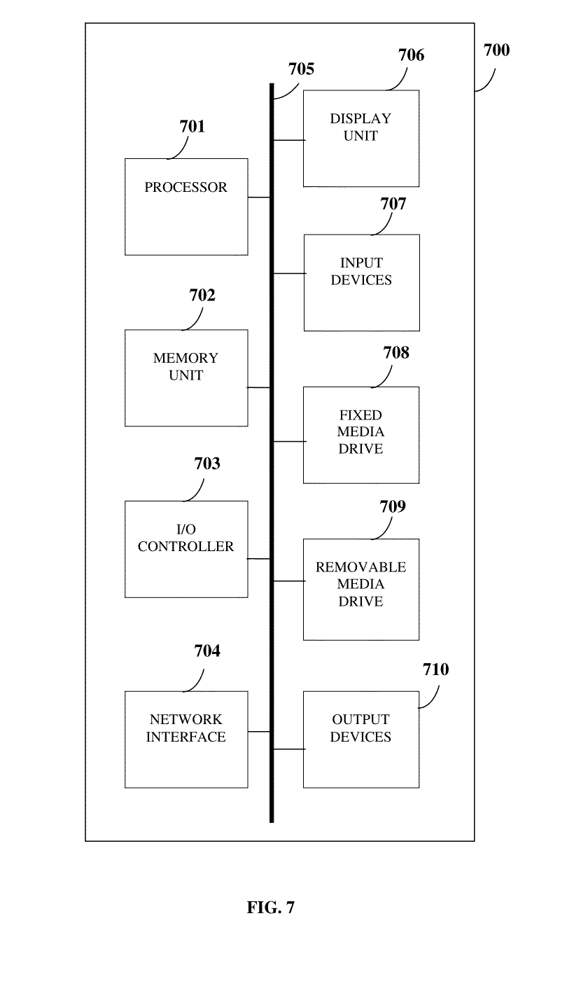

FIG. 7 exemplarily illustrates the architecture of a computer system 700 employed by the video generator system 603 for generating a video. The video generator system 603 of the computer implemented system 600 exemplarily illustrated in FIG. 6 employs the architecture of the computer system 700 exemplarily illustrated in FIG. 7. The computer system 700 is programmable using a high level computer programming language. The computer system 700 may be implemented using programmed and purposeful hardware.

The video generator system 603 communicates with user devices, for example, 601a, 601b, and 601c of each of the users registered with the video generator system 603 via a network 602, for example, a short range network or a long range network. The network 602 is, for example, the internet, a local area network, a wide area network, a wired network, a wireless network, a mobile communication network, etc. The computer system 700 comprises, for example, a processor 701, a memory unit 702 for storing programs and data, an input/output (I/O) controller 703, a network interface 704, a data bus 705, a display unit 706, input devices 707, a fixed media drive 708, a removable media drive 709 for receiving removable media, output devices 710, etc.

The term “processor” refers to any one or more microprocessors, central processing unit (CPU) devices, finite state machines, computers, microcontrollers, digital signal processors, logic, a logic device, an electronic circuit, an application specific integrated circuit (ASIC), a field-programmable gate array (FPGA), a chip, etc., or any combination thereof, capable of executing computer programs or a series of commands, instructions, or state transitions. The processor 701 may also be implemented as a processor set comprising, for example, a general purpose microprocessor and a math or graphics co-processor. The processor 701 is selected, for example, from the Intel® processors such as the Itanium® microprocessor or the Pentium® processors, Advanced Micro Devices)(AMD® processors such as the Athlon® processor, UltraSPARC® processors, microSPARC™ processors, Hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, etc. The video generator system 603 disclosed herein is not limited to a computer system 700 employing a processor 701. The computer system 700 may also employ a controller or a microcontroller.

The memory unit 702 is used for storing programs, applications, and data. For example, the template acquisition module 603a, the customizable element identification module 603b, the template presentation module 603c, the data acquisition module 603d, the rendering module 603e, the video generation module 603f, and the preview generation module 603g are stored in the memory unit 702 of the computer system 700. The memory unit 702 is, for example, a random access memory (RAM) or another type of dynamic storage device that stores information and instructions for execution by the processor 701. The memory unit 702 also stores temporary variables and other intermediate information used during execution of the instructions by the processor 701. The computer system 700 further comprises a read only memory (ROM) or another type of static storage device that stores static information and instructions for the processor 701.

The I/O controller 703 controls input actions and output actions performed by the video generator system 603. The network interface 704 enables connection of the computer system 700 to the network 602. For example, the video generator system 603 connects to the network 602 via the network interface 704. In an embodiment, the network interface 704 is provided as an interface card also referred to as a line card. The network interface 704 comprises, for example, one or more of an infrared (IR) interface, an interface implementing Wi-Fi® of the Wireless Ethernet Compatibility Alliance, Inc., a universal serial bus (USB) interface, a FireWire® interface of Apple, Inc., a Bluetooth® interface, an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, and Ethernet communication interfaces, asynchronous transfer mode (ATM) interfaces, a high-speed serial interface (HSSI), a fiber distributed data interface (FDDI), interfaces based on transmission control protocol (TCP)/internet protocol (IP), interfaces based on wireless communications technology such as satellite technology, radio frequency (RF) technology, near field communication, etc. The data bus 705 permits communications between the modules, for example, 603a, 603b, 603c, 603d, 603e, 603f, 603g, etc., of the video generator system 603.

The display unit 706 of the video generator system 603, via the interactive interface 603h, displays information, display interfaces, user interface elements such as text fields, checkboxes, text boxes, windows, etc., for allowing a user to submit media content. The display unit 706 comprises, for example, a liquid crystal display, a plasma display, an organic light emitting diode (OLED) based display, etc. The input devices 707 are used for inputting data into the computer system 700. For example, a user may enter media content from the user device, for example, 601a, 601b, or 601c comprising video content, audio content, image content, textual content, multimedia content, and any combination, etc., using the input devices 707. The input devices 707 are, for example, a keyboard such as an alphanumeric keyboard, a joystick, a pointing device such as a computer mouse, a touch pad, a light pen, a physical button, a pointing device, a touch sensitive display device, a track ball, a pointing stick, any device capable of sensing a tactile input, etc.

Computer applications and programs are used for operating the computer system 700. The programs are loaded onto the fixed media drive 708 and into the memory unit 702 of the computer system 700 via the removable media drive 709. In an embodiment, the computer applications and programs may be loaded directly via the network 602. Computer applications and programs are executed by double clicking a related icon displayed on the display unit 706 using one of the input devices 707. The output devices 710 output the results of operations performed by the video generator system 603. For example, the video generator system 603 transmits the generated video, that is, the preview video or the final video, using the output devices 710.

The processor 701 executes an operating system, for example, the Linux® operating system, the Unix® operating system, any version of the Microsoft® Windows® operating system, the Mac OS of Apple Inc., the IBM® OS/2, VxWorks® of Wind River Systems, inc., QNX Neutrino® developed by QNX Software Systems Ltd., Palm OS®, the Solaris operating system developed by Sun Microsystems, Inc., the Android operating system, Windows Phone™ operating system of Microsoft Corporation, BlackBerry® operating system of Research in Motion Limited, the iOS operating system of Apple Inc., the Symbian® operating system of Symbian Foundation Limited, etc. The computer system 700 employs the operating system for performing multiple tasks. The operating system is responsible for management and coordination of activities and sharing of resources of the computer system 700. The operating system further manages security of the computer system 700, peripheral devices connected to the computer system 700, and network connections. The operating system employed on the computer system 700 recognizes, for example, inputs provided by the user using one of the input devices 707, the output display, files, and directories stored locally on the fixed media drive 708, for example, a hard drive. The operating system on the computer system 700 executes different programs using the processor 701. The processor 701 and the operating system together define a computer platform for which application programs in high level programming languages are written.

The processor 701 retrieves instructions for executing the modules, for example, 603a, 603b, 603c, 603d, 603e, 603f, 603g, etc., of the video generator system 603 from the memory unit 702. A program counter determines the location of the instructions in the memory unit 702. The program counter stores a number that identifies the current position in the program of each of the modules, for example, 603a, 603b, 603c, 603d, 603e, 603f, 603g, etc., of the video generator system 603. The instructions fetched by the processor 701 from the memory unit 702 after being processed are decoded. The instructions are stored in an instruction register in the processor 701. After processing and decoding, the processor 701 executes the instructions. For example, the template acquisition module 603a defines instructions for acquiring multiple video templates from one or more sources, for example, third party video template vendors. The customizable element identification module 603b defines instructions for identifying one or more customizable elements in each of the video templates. The customizable element identification module 603b also defines instructions for identifying and modifying one or more properties of each of the identified customized elements in each of the video templates. The customizable element identification module 603b also defines instructions for tagging each of the identified customizable elements in each of the video templates on acquisition of the video templates from the sources. The customizable element identification module 603b also defines instructions for displaying the identified customizable elements in each of the sourced video templates on the user device, for example, 601a, 601b, or 601c, via the interactive interface 603h. The template presentation module 603c defines instructions for presenting the video templates comprising the identified customizable elements to the user device, for example, 601a, 601b, or 601c via the interactive interface 603h for enabling selection and individual customization of one or more of the presented video templates.

The data acquisition module 603d defines instructions for acquiring a selection of one or more of the presented video templates from the user device, for example, 601a, 601b, or 601c via the interactive interface 603h. The rendering module 603e defines instructions for rendering the identified customizable elements of the selected video templates to the user device, for example, 601a, 601b, or 601c via the interactive interface 603h. The data acquisition module 603d also defines instructions for acquiring media content for each of the rendered customizable elements of each of the selected video templates from the user device, for example, 601a, 601b, or 601c via the interactive interface 603h. The video generation module 603f defines instructions for generating the video by modifying each of the rendered customizable elements of a selected video template using the acquired media content and collating the modified customizable elements of the selected video template. In an embodiment, the data acquisition module 603d defines the instructions for acquiring an arrangement position for each of the rendered customizable elements of the selected video templates from the user device, for example, 601a, 601b, or 601c via the interactive interface 603h. In this embodiment, the video generation module 603f defines instructions for collating the modified customizable elements of each of the selected video templates using the acquired arrangement position of each of the rendered customizable elements. The preview generation module 603g defines instructions for generating and presenting a preview for each of the modified customizable elements of each of the selected video templates on the user device, for example, 601a, 601b, or 601c via the interactive interface 603h for acquiring approval of the modified customizable elements from the user device, for example, 601a, 601b, or 601c to proceed with the generation of the video.

The processor 701 of the computer system 700 employed by the video generator system 603 retrieves the instructions defined by the template acquisition module 603a, the customizable element identification module 603b, the template presentation module 603c, the data acquisition module 603d, the rendering module 603e, the video generation module 603f, and the preview generation module 603g, and executes the instructions, thereby performing one or more processes defined by those instructions.

At the time of execution, the instructions stored in the instruction register are examined to determine the operations to be performed. The processor 701 then performs the specified operations. The operations comprise arithmetic operations and logic operations. The operating system performs multiple routines for performing a number of tasks required to assign the input devices 707, the output devices 710, and memory for execution of the modules, for example, 603a, 603b, 603c, 603d, 603e, 603f, 603g, 603h, etc., of the video generator system 603. The tasks performed by the operating system comprise, for example, assigning memory to the modules, for example, 603a, 603b, 603c, 603d, 603e, 603f, 603g, 603h, etc., of the video generator system 603, and to data used by the video generator system 603, moving data between the memory unit 702 and disk units, and handling input/output operations. The operating system performs the tasks on request by the operations and after performing the tasks, the operating system transfers the execution control back to the processor 701. The processor 701 continues the execution to obtain one or more outputs. The outputs of the execution of the modules, for example, 603a, 603b, 603c, 603d, 603e, 603f, 603g, 603h, etc., of the video generator system 603 are displayed to the user on the display unit 706.

For purposes of illustration, the detailed description refers to the video generator system 603 being run locally on a computer system 700; however the scope of the computer implemented method and system 600 disclosed herein is not limited to the video generator system 603 being run locally on the computer system 700 via the operating system and the processor 701, but may be extended to run remotely over the network 602 by employing a web browser and a remote server, a mobile phone, or other electronic devices. One or more portions of the computer system 700 may be distributed across one or more computer systems (not shown) coupled to the network 602.

Disclosed herein is also a computer program product comprising a non-transitory computer readable storage medium that stores computer program codes comprising instructions executable by at least one processor 701 for generating a video, for example, a preview video or a final video. As used herein, the term “non-transitory computer readable storage medium” refers to all computer readable media, for example, non-volatile media such as optical discs or magnetic disks, volatile media such as a register memory, a processor cache, etc., and transmission media such as wires that constitute a system bus coupled to the processor 701, except for a transitory, propagating signal.

The computer program codes comprise a first computer program code for acquiring multiple video templates from one or more of multiple sources such as third party video template vendors; a second computer program code for identifying one or more customizable elements in each of the video templates; a third computer program code for presenting the video templates comprising the identified customizable elements to a user device, for example, 601a, 601b, or 601c via the interactive interface 603h for enabling selection, arrangement, and individual customization of each of the identified customizable elements of each of the presented video templates; a fourth computer program code for acquiring a selection of one or more of the presented video templates from the user device, for example, 601a, 601b, or 601c via the interactive interface 603h; a fifth computer program code for rendering the identified customizable elements of the selected video templates to the user device, for example, 601a, 601b, or 601c via the interactive interface 603h based on the acquired selection; a sixth computer program code for acquiring media content for each of the rendered customizable elements of each of the selected video templates from the user device, for example, 601a, 601b, or 601c via the interactive interface 603h; and a seventh computer program code for generating the video by modifying each of the rendered customizable elements of a selected video template using the acquired media content and collating the modified customizable elements of the selected video template. In an embodiment, the computer program codes further comprise an eighth computer program code for identifying and modifying one or more properties of each of the identified customizable elements in each of the video templates.

The computer program product disclosed herein further comprises one or more additional computer program codes for performing additional steps that may be required and contemplated for generating a video. In an embodiment, a single piece of computer program code comprising computer executable instructions performs one or more steps of the computer implemented method disclosed herein for generating a video. The computer program codes comprising computer executable instructions are embodied on the non-transitory computer readable storage medium. The processor 701 of the computer system 700 retrieves these computer executable instructions and executes them. When the computer executable instructions are executed by the processor 701, the computer executable instructions cause the processor 701 to perform the steps of the computer implemented method for generating a video, for example, a preview video or a final video.

FIG. 8A exemplarily illustrates a screenshot of an interactive interface 603h provided by the video generator system 603 exemplarily illustrated in FIG. 6, showing multiple video templates presented to a user. The video generator system 603 presents the video templates to the user via the interactive interface 603h. The video generator system 603 provides multiple links, for example, “Choose Style”, “Insert Graphics”, “Choose Music”, “Generate the Video”, etc., on the interactive interface 603h. When a user clicks on the “Choose Style” link on the interactive interface 603h, the video generator system 603 displays multiple video templates sourced, for example, from the Adobe® After Effects® software on the interactive interface 603h. The video generator system 603 further provides the link “Order By” that enables a user to choose a mode of arrangement of the video templates on the interactive interface 603h. The mode of arrangement is, for example, based on popularity, an alphabetical order, size of the video template, etc. To obtain an overview of all the user's video projects, the user may activate or click a “My Videos” interface element on the interactive interface 603h to open existing video projects for customization and production.

FIGS. 8B-8C exemplarily illustrate screenshots of the interactive interface 603h provided by the video generator system 603 exemplarily illustrated in FIG. 6, for acquiring media content for the identified customizable elements of a video template selected by a user. The video generator system 603 allows generation of videos, for example, using text, photos, and video footage that the user uploads to the video generator system 603. Consider an example where the video generator system 603 identifies 15 customizable elements or customizable video parts in the video template selected by the user. The video generator system 603 then renders each of the 15 identified customizable elements to the user via the interactive interface 603h and prompts the user to provide appropriate media content for the identified customizable elements. For example, the video generator system 603 presents a first identified customizable element or part 1, and displays the message, “On part 1, open a photo or a video clip and write a description for it”. The video generator system 603 further provides an “Open File” interface element or button for opening a file containing the media content for the identified customizable element, located on the user device, for example, 601a, 601b, or 601c exemplarily illustrated in FIG. 6. The video generator system 603 then uploads the file opened by the user using the “Open File” interface element onto the video generator system 603. The video generator system 603 further provides a tab on the interactive interface 603h for enabling the user to enter descriptive text for the uploaded file. The video generator system 603 also provides a “Save And View This Part” interface element or button on the interactive interface 603h to enable the user to save and view a particular modified customizable element or part.

In an embodiment, the video generator system 603 enables the user to replace a default music track of the selected video template with a music track of the user's choice as exemplarily illustrated in FIG. 8C. The video generator system 603 provides a “Choose Music” link on the interactive interface 603h for replacing the default music track with the music track of the user's choice. In an embodiment, the video generator system 603 allows the user to upload the music track onto the video generator system 603 from the user device, for example, 601a, 601b, or 601c via the network 602. In another embodiment, the video generator system 603 stores a collection of music tracks in the database 212 exemplarily illustrated in FIG. 2B and FIG. 6, for enabling the user to choose the music track for the video from among the collection of music tracks.

FIG. 8D exemplarily illustrates a screenshot of the interactive interface 603h of the video generator system 603 exemplarily illustrated in FIG. 6, for generating the video. The video generator system 603 provides a “Generate the Video” link on the interactive interface 603h for enabling the user to generate the video. When a user clicks on the “Generate the Video” link, the video generator system 603 directs the user to a webpage with an interface for acquiring payment from the user and generating the video on receiving the payment. Consider an example where a user pays for generation of three preview videos and a final video. The video generator system 603 provides a “generate a preview” interface element on the interactive interface 603h. When the user clicks on the “generate a preview” interface element, the video generator system 603 initiates generation of a first preview video. The video generator system 603 also provides a “play video” link, a “download” link, and a “change music” link on the interactive interface 603h. When the user clicks the “play video” link on the interactive interface 603h, the video generator system 603 plays the preview video. The “download” link enables the user to download the preview video from the video generator system 603 to the user device, for example, 601a, 601b, or 601c. The “change music” link enables the user to change the music track of the preview video.

When the user clicks the “generate a preview” button on the interactive interface 603h, the video generator system 603 initiates generation of a single preview video. After a predetermined time period, for example, about a few minutes the user can view the single preview video generated by the video generator system 603. If the user discovers any inaccuracies in the customization, the video generator system 603 enables the user to go back to previous steps and modify the customizable elements of the selected video template. Therefore, the preview video enables the user to ensure that the customization performed in earlier steps is accurate. When the user is satisfied with the preview video, the video generator system 603 initiates the process of generating the final video. The video generator system 603 further provides a “generate a final video” interface element on the interactive interface 603h that initiates generation of the final video. The user can watch the final video by clicking on the “play video” link on the interactive interface 603h after a predetermined time period, for example, of about a few minutes. The user can then download the final video to the user device, for example, 601a, 601b, or 601c by clicking on the “download” link provided on the interactive interface 603h.

Consider another example where a user wishes to create a movie. The user selects a movie style or a video template that suits the user's needs via the interactive interface 603h. When the user selects the video template to use and presses a “generate the video” interface element on the interactive interface 603h exemplarily illustrated in FIGS. 8A-8D, the video generator system 603 creates a video project to allow the user to start the process of sending text, pictures, footage, etc. The user can edit movie graphics by uploading graphic files such as photos and movie clips, and writing text via the interactive interface 603h. A video template for a movie is divided in different customizable parts or customizable elements, and each part or customizable element can be customized with the user's graphics. The user may request for a movie preview to verify the accuracy of the movie based on the user's preference and requirement. After the graphics have been inserted into a part or a customizable element, the user can press, for example, the “generate a preview” interface element on the interactive interface 603h to view a preview picture that shows how the movie will look. When all the customization parts are customized, the user may press a “Close” interface element on the interactive interface 603h to terminate the customization process. If the user wishes to change the default movie music, the user may press a “choose music” interface element on the interactive interface 603h exemplarily illustrated in FIGS. 8A-8D. The user can either upload a music file or select a music track from a collection maintained by the video generator system 603. The user may also change the music at a later point in time, after the movie has been generated. The user may then request for generation of a free preview movie via the interactive interface 603h. The video generator system 603 initiates generation of a small low quality movie for the preview. The purpose of the preview movie is for the user to make sure the movie is how the user wants the movie to be and free the movie from errors. If anything needs to be changed, the user may return to the first step and change the graphics. If the preview movie is accurate, the user may request the generation of the final movie. The video generator system 603 sends a notification, for example, via electronic mail when the generation of the movie is complete. When the final movie is ready, the user may change the music and the privacy settings on a video page hosted by the video generator system 603. The user may also download the movie in various sizes and formats from the video generator system 603 via the interactive interface 603h.

It will be readily apparent that the various methods, algorithms, and computer programs disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a similar device. Non-transitory computer readable media comprise all computer readable media, for example, non-volatile media, volatile media, and transmission media, except for a transitory, propagating signal. Non-volatile media comprise, for example, optical discs or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to a processor, etc. Common forms of computer readable media comprise, for example, a floppy disk, a flexible disk, a hard disk, magnetic tape, a laser disc, a Blu-ray Disc®, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

The computer programs that implement the methods and algorithms disclosed herein may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of programming languages that can be used comprise C, C++, C#, Java®, Fortran, Ruby, Pascal, Perl®, Python®, Visual Basic®, MATLAB®, etc. Other object-oriented, functional, scripting, and/or logical programming languages may also be used. The computer program codes or software programs may be stored on or in one or more mediums as object code. Various aspects of the method and system disclosed herein may be implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. Various aspects of the method and system disclosed herein may be implemented as programmed elements, or non-programmed elements, or any suitable combination thereof. The computer program product disclosed herein comprises computer executable instructions embodied in a non-transitory computer readable storage medium, wherein the computer program product comprises one or more computer program codes for implementing the processes of various embodiments.

Where databases are described such as the database 212, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment comprising one or more computers that are in communication with one or more devices via a network. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices may comprise processors, for example, the Intel® processors, Advanced Micro Devices (AMD®) processors, UltraSPARC® processors, Hp® processors, International Business Machines (IBM®) processors, RISC based computer processors of ARM Holdings, Motorola® processors, etc., that are adapted to communicate with the computers. In an embodiment, each of the computers is equipped with a network communication device, for example, a network interface card, a modem, or other network connection device suitable for connecting to a network. Each of the computers and the devices executes an operating system, for example, the Linux® operating system, the Unix® operating system, any version of the Microsoft® Windows® operating system, the Mac OS of Apple Inc., the IBM® OS/2, the Palm OS®, the Solaris operating system developed by Sun Microsystems, Inc., or any other operating system. Handheld devices execute operating systems, for example, the Android operating system, the Windows Phone™ operating system of Microsoft Corporation, the BlackBerry® operating system of Research in Motion Limited, the iOS operating system of Apple Inc., the Symbian® operating system of Symbian Foundation Limited, etc. While the operating system may differ depending on the type of computer, the operating system will continue to provide the appropriate communications protocols to establish communication links with the network. Any number and type of machines may be in communication with the computers.

The present invention is not limited to a particular computer system platform, processor, operating system, or network. One or more aspects of the present invention may be distributed among one or more computer systems, for example, servers configured to provide one or more services to one or more client computers, or to perform a complete task in a distributed system. For example, one or more aspects of the present invention may be performed on a client-server system that comprises components distributed among one or more server systems that perform multiple functions according to various embodiments. These components comprise, for example, executable, intermediate, or interpreted code, which communicate over a network using a communication protocol. The present invention is not limited to be executable on any particular system or group of systems, and is not limited to any particular distributed architecture, network, or communication protocol.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. A computer implemented method for generating a video, comprising:
providing a video generator system comprising at least one processor configured to generate said video;
acquiring a plurality of video templates from one or more of a plurality of sources by said video generator system;
identifying one or more customizable elements in each of said video templates by said video generator system;
presenting said video templates comprising said identified one or more customizable elements to a user device by said video generator system via an interactive interface provided by said video generator system for enabling selection and individual customization of each of said identified one or more customizable elements of each of one or more of said presented video templates;
acquiring a selection of one or more of said presented video templates from said user device by said video generator system via said interactive interface;
rendering said identified one or more customizable elements of said one or more of said presented video templates to said user device by said video generator system via said interactive interface based on said acquired selection;
acquiring media content for each of said rendered one or more customizable elements of said one or more of said presented video templates from said user device by said video generator system via said interactive interface; and
generating said video by said video generator system by modifying each of said rendered one or more customizable elements of each of said one or more of said presented video templates using said acquired media content and collating said modified each of said rendered one or more customizable elements of said each of said one or more of said presented video templates.

2. The computer implemented method of claim 1, further comprising identifying and modifying one or more properties of each of said identified one or more customizable elements in said each of said video templates by said video generator system.

3. The computer implemented method of claim 1, further comprising acquiring an arrangement position for said each of said rendered one or more customizable elements of said one or more of said presented video templates from said user device by said video generator system via said interactive interface, wherein said video generator system is configured to collate said modified each of said rendered one or more customizable elements of said each of said one or more of said presented video templates using said acquired arrangement position of said each of said rendered one or more customizable elements.

4. The computer implemented method of claim 1, further comprising generating and presenting a preview for said modified each of said rendered one or more customizable elements of said each of said one or more of said presented video templates on said user device by said video generator system via said interactive interface for acquiring approval of said modified each of said rendered one or more customizable elements from said user device to proceed with said generation of said video.

5. The computer implemented method of claim 1, further comprising tagging each of said identified one or more customizable elements in each of said video templates by said video generator system on said acquisition of said video templates from said one or more of said sources.

6. The computer implemented method of claim 1, further comprising displaying said identified one or more customizable elements in each of said video templates on said user device by said video generator system via said interactive interface.

7. The computer implemented method of claim 1, wherein said media content comprises one of video content, audio content, audiovisual content, image content, textual content, multimedia content, and any combination thereof.

8. The computer implemented method of claim 1, wherein said video generator system is one of downloadable on said user device and accessible by said user device via a network.

9. A video generator system comprising:
at least one processor;
a non-transitory computer readable storage medium communicatively coupled to said at least one processor, said non-transitory computer readable storage medium configured to store modules of said video generator system, said at least one processor configured to execute said modules of said video generator system, said modules of said video generator system comprising:
a template acquisition module configured to acquire a plurality of video templates from one or more of a plurality of sources;
a customizable element identification module configured to identify one or more customizable elements in each of said video templates;
a template presentation module configured to present said video templates comprising said identified one or more customizable elements to a user device via an interactive interface provided by said video generator system for enabling selection and individual customization of each of said identified one or more customizable elements of each of one or more of said presented video templates;
a data acquisition module configured to acquire a selection of one or more of said presented video templates from said user device via said interactive interface;
a rendering module configured to render said identified one or more customizable elements of said one or more of said presented video templates to said user device via said interactive interface based on said acquired selection;
said data acquisition module configured to acquire media content for each of said rendered one or more customizable elements of said one or more of said presented video templates from said user device via said interactive interface; and
a video generation module configured to generate said video by modifying each of said rendered one or more customizable elements of each of said one or more of said presented video templates using said acquired media content and collating said modified each of said rendered one or more customizable elements of said each of said one or more of said presented video templates.

10. The video generator system of claim 9, wherein said customizable element identification module is further configured to identify and modify one or more properties of each of said identified one or more customizable elements in said each of said video templates.

11. The video generator system of claim 9, wherein said customizable element identification module is further configured to tag each of said identified one or more customizable elements in each of said video templates on said acquisition of said video templates from said one or more of said sources.

12. The video generator system of claim 9, wherein said data acquisition module is further configured to acquire an arrangement position for said each of said rendered one or more customizable elements of said one or more of said presented video templates from said user device via said interactive interface, wherein said video generation module is configured to collate said modified each of said rendered one or more customizable elements of said each of said one or more of said presented video templates using said acquired arrangement position of said each of said rendered one or more customizable elements.

13. The video generator system of claim 9, wherein said modules of said video generator system further comprise a preview generation module configured to generate and present a preview for said modified each of said rendered one or more customizable elements of said each of said one or more of said presented video templates on said user device via said interactive interface for acquiring approval of said modified each of said rendered one or more customizable elements from said user device to proceed with said generation of said video.

14. The video generator system of claim 9, wherein said customizable element identification module is configured to tag and display said identified one or more customizable elements in each of said video templates on said user device via said interactive interface.

15. The video generator system of claim 9, further comprising a database configured to store template data associated with each of said video templates, information on said identified one or more customizable elements of said each of said video templates, information on properties of each of said identified one or more customizable elements in said each of said video templates, information on said acquired selection of said one or more of said presented video templates, said acquired media content, and user data.

16. The video generator system of claim 9, wherein said media content comprises one of video content, audio content, audiovisual content, image content, textual content, multimedia content, and any combination thereof.

17. The video generator system of claim 9 being one of downloadable on said user device and accessible by said user device via a network.

18. A computer program product comprising a non-transitory computer readable storage medium, said non-transitory computer readable storage medium storing computer program codes that comprise instructions executable by at least one processor, said computer program codes comprising:
a first computer program code for acquiring a plurality of video templates from one or more of a plurality of sources;
a second computer program code for identifying one or more customizable elements in each of said video templates;
a third computer program code for presenting said video templates comprising said identified one or more customizable elements to a user device via an interactive interface for enabling selection, arrangement, and individual customization of each of said identified one or more customizable elements of each of one or more of said presented video templates;
a fourth computer program code for acquiring a selection of one or more of said presented video templates from said user device via said interactive interface;
a fifth computer program code for rendering said identified one or more customizable elements of said one or more of said presented video templates to said user device via said interactive interface based on said acquired selection;
a sixth computer program code for acquiring media content for each of said rendered one or more customizable elements of said one or more of said presented video templates from said user device via said interactive interface; and
a seventh computer program code for generating said video by modifying each of said rendered one or more customizable elements of each of said one or more of said presented video templates using said acquired media content and collating said modified each of said rendered one or more customizable elements of said each of said one or more of said presented video templates.

19. The computer program product of claim 18, wherein said computer program codes further comprise an eighth computer program code for identifying and modifying one or more properties of each of said identified one or more customizable elements in said each of said video templates.
